(19) United States
(12) Patent Application Publication
(10) Pub. No.: US 2011/0087995 A1
(43) Pub. Date: Apr. 14, 2011

(54) METHOD FOR SIMPLIFYING THE INPUT, BY A USER, OF A VERY LONG NUMERICAL SEQUENCE, AND CORRESPONDING DEVICE AND COMPUTER PROGRAM PRODUCT

(75) Inventor: David Naccache, Paris (FR)

(73) Assignee: Campagnie Industrielle et Financiere D'Ingenierie Ingenico, Neuilly-Sur-Seine (FR)

(21) Appl. No.: 12/904,787

(22) Filed: Oct. 14, 2010

(30) Foreign Application Priority Data
Oct. 14, 2009 (FR) 0957215

(51) Int. Cl. G06F 3/048

(52) U.S. Cl. 715/816

(57) ABSTRACT

A method is provided for simplifying the input, by a user, of a very long numerical sequence, via an input module of a communications terminal. The method includes: inputting, via the input module, at least one word forming alphanumerical sequences, the word or words being previously associated with the numerical sequence; transferring the word or words to a conversion module; and receiving, by the input module, the numerical sequence, provided by the conversion module, after the words have been processed. The words are determined and provided to the user by the conversion module, in a prior initialization phase, by a conversion algorithm that associates the word or words in a unique way with a very long numerical sequence. The word or words are chosen from a pre-selected dictionary consisting of words that are of significance to the user.

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of the input, by users, of very long numerical sequences, on input modules such as computer keyboards, payment terminals, etc.

To be more specific, the disclosure applies to the simplification, for the user, of procedures for inputting such numerical sequences. Such procedures are required for example in order to authenticate a user when he or she requires access to a building, or to a remote service, or again for the validation of remote banking transactions.

### BACKGROUND OF THE DISCLOSURE

To ensure the security of locations and remote access to services, via the Internet for example, user authentication is increasingly required. This authentication may be implemented using different means, and in different forms, including an invitation to input a very long numerical sequence, generally known only to the user and to the service provider.

It is thus quite usual to ensure security of access to services, to a program or database on a private network or on the Internet by inputting personal codes, of varying lengths and therefore of varying difficulty for the user to memorize and to input.

For example, there is enormous potential today for remote banking transactions, and particularly via the Internet which affords the opportunity to pay for purchases, goods and services, on line, by using a “conventional” bank card.

Most of the time, on-line purchasing by bank card requires the user to input at least one bank card identification number, often together with the input of data such as the card expiry date, or an additional code known as a cryptogram.

One drawback with this on-line banking transaction technology lies in the fact that the user is obliged to input his bank card ID number, said number comprising a succession of sixteen digits, an expiry date and an additional three-digit code (for example a Card Holder Verification, or CHV, code), which are difficult to remember and to input from memory.

The advantages afforded to the user by the opportunity to perform remote banking transactions are thus mitigated by the fact that the user has to have, near at hand, his bank card, or a piece of paper, with his bank card ID number written on it. A user may thus change his mind and fail to validate said transaction, simply because he cannot be bothered to go and fetch his bank card, or because he doesn't have it near at hand, thereby causing a loss of revenue to the seller on the remote on-line site.

### SUMMARY

An aspect of the disclosure relates to a method for simplifying the input, by a user, of a very long numerical sequence, via an input module of a communications terminal.

According to an exemplary embodiment, such a method comprises the following steps:
the input, via said input module, of at least one word forming alphanumerical sequences, said word or words being previously associated with said numerical sequence;
the transfer of said word or words to a conversion module;
the reception, by said input module, of said numerical sequence, provided by said conversion module, after said words have been processed,

said words having been determined and provided to the user by said conversion module, in a prior initialization phase, by means of a conversion algorithm that associates said word or words in a unique way with a very long numerical sequence, said word or words being chosen from a pre-selected dictionary consisting of words that are of significance to the user.

An exemplary embodiment is thus based on a new and inventive approach to the inputting, by a user, of very long numerical sequences, based on the conversion of said sequences into successions of words that are easy to remember for a user, thereby releasing him from the need to memorize a long succession of digits.

In particular, said step of inputting at least one word is carried out after a step of requesting the use of a simplified input mode by said user.

Thus, according to this alternative, the user is able to choose the simplified input mode, when he is connected to an Internet page for example, by clicking on a button that allows him to access this simplified input mode.

In this way, the choice of input mode is left to the user, so as to remain compatible with the “conventional” operating mode which comprises inputting the very long numerical sequence.

According to one particular aspect of the disclosure, the simplification method employs two alternative input fields, a first field for directly inputting said very long numerical sequence and a second field for inputting said word or words, and in that said word or words are transferred to said conversion module when said step of inputting at least one word is carried out in said second field.

According to this alternative, two input fields are offered to the user, one for a “normal” inputting of a very long numerical sequence and the other for a “simplified” inputting of a succession of words. In the latter case, the input words are only transferred to the conversion module when the simplified input field is filled in.

Here too, compatibility with “conventional” operation is preserved, particularly for users who do not have a succession of words associated with the required very long numerical sequence.

In particular, said words are chosen from a dictionary that comprises only words in common parlance for said user.

According to one particular aspect of the disclosure, the simplification method also comprises a prior step of choosing a dictionary from a plurality of dictionaries.

Then, since the words provided to the user are taken from a dictionary that comprises only words in common parlance, they are easy to memorize.

The choice of dictionary may be offered to the user at the time of the prior initialization phase, so that the user can choose a dictionary in which the words really are common parlance for him. This can be particularly advantageous for example in the situation where a user's mother, or preferred, tongue is not that provided as a default by the system.

For example, said words include a number of letters below a preset threshold.

Since the words provided to the user are of restricted length, they are then easier to input in terms of the number of characters to be input.

In particular, declensions or conjugations of said words may be chosen.

Each word can thus be used in a plurality of declensions, for example in the singular, plural, masculine, feminine, in the infinitive or conjugated for a verb, etc, which means that an additional encoding bit can be used per word. In this way, the number of usable words is larger, which means that longer numerical sequences can be encoded.

According to one particular aspect of the disclosure, said numerical sequence corresponds to a bank ID number, said user input being required for the authentication of a remote banking transaction.

The present disclosure thus applies in particular to remote banking transactions by means of a bank card, which conventionally require the input of a long bank ID code, given on the bank card, that is difficult to memorize on account of its length.

According to this inventive embodiment, a user invited to input a bank card ID in order to validate a remote banking transaction is therefore able to enter instead an easy-to-remember succession of x words, making the transaction more ergonomic and user-friendly, by releasing him from the need to have near at hand his bank card on which the usually required ID number is given.

The disclosure also relates to a device for simplifying the input, by a user, of a very long numerical sequence, associated with an input module of a communications terminal, and comprising:
means for the input, via said input module, of at least one word forming alphanumerical sequences, said word or words being previously associated with said numerical sequence;
means for the transfer of said word or words to a conversion module;
means for the reception, via said input module, of said numerical sequence, provided by said conversion module, after said words have been processed, said words having been determined and provided to the user by said conversion module, in a prior initialization phase, by means of a conversion algorithm that associates said word or words in a unique way a very long numerical sequence, said word or words being chosen from a pre-selected dictionary consisting of words that are of significance to the user.

Said device is in particular capable of implementing the steps in the simplification method previously described. This may for example be a computer, a radio telephone terminal, or a Personal Digital Assistant (PDA), etc.

Finally, another aspect of the disclosure relates to a computer program product downloadable from a communications network and/or recorded on a non-transient medium that can be read by a computer and/or run by a processor, comprising program code instructions for implementing the method for simplifying the input, by a user, of a very long numerical sequence, as previously described.

### BRIEF DESCRIPTION OF THE DRAWINGS

Other characteristics and advantages will become clearer from reading the following description of one particular embodiment, given simply by way of information and non-restrictively, and the appended drawings, in which,

FIG. 1 shows the main steps in the method for simplifying the input, by a user, of a very long numerical sequence according to one particular embodiment of the disclosure;

FIG. 2 shows the initialization phase of the method for simplifying the input, by a user, of a very long numerical sequence according to one particular embodiment of the disclosure;

FIGS. 3a, 3b and 4a, 4b show two examples of simplified inputting according to two embodiments of the disclosure,

FIG. 5 shows the structure of a device for simplifying the input, by a user, of a very long numerical sequence implementing the technique of simplifying the input, by a user, of a very long numerical sequence according to one embodiment of the disclosure.

### DETAILED DESCRIPTION OF ILLUSTRATIVE EMBODIMENTS

### 1. General Principle

The general principle of an exemplary embodiment of the disclosure is based on the conversion of a very long numerical sequence into one or more words from a pre-selected dictionary consisting of words that are of significance to a user, and on the inputting of this word or these words instead of the very long numerical sequence, so as to make said input less constricting for the user.

Indeed, for a user, memorizing one or more significant words is much more straightforward than memorizing a very long numerical sequence. It is therefore more straightforward for a user to input this word or these words, from memory, than to input a very long numerical sequence that is difficult to memorize.

Moreover, the risks of input error are more numerous when the number of characters to be input is large. The inventive simplification method therefore allows the risk of input error to be reduced, thereby saving time for the user.

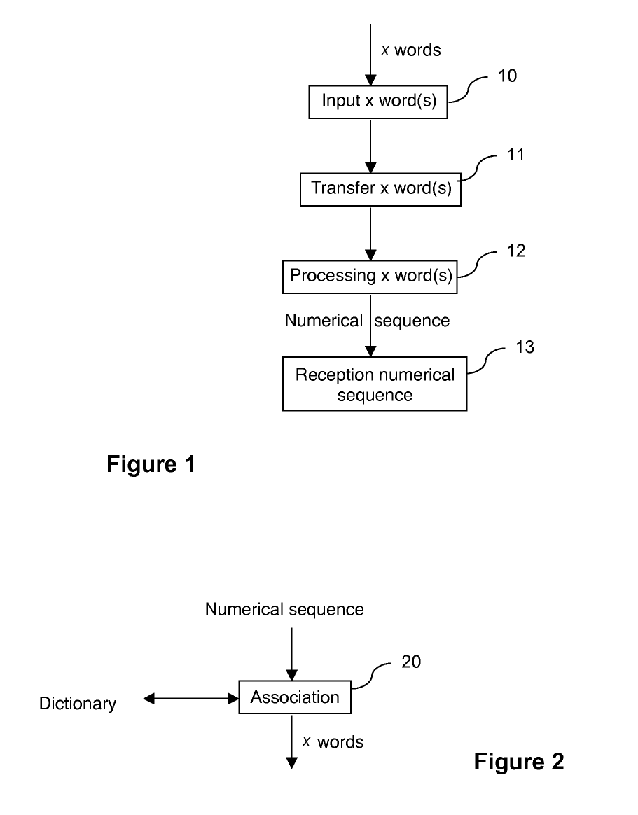

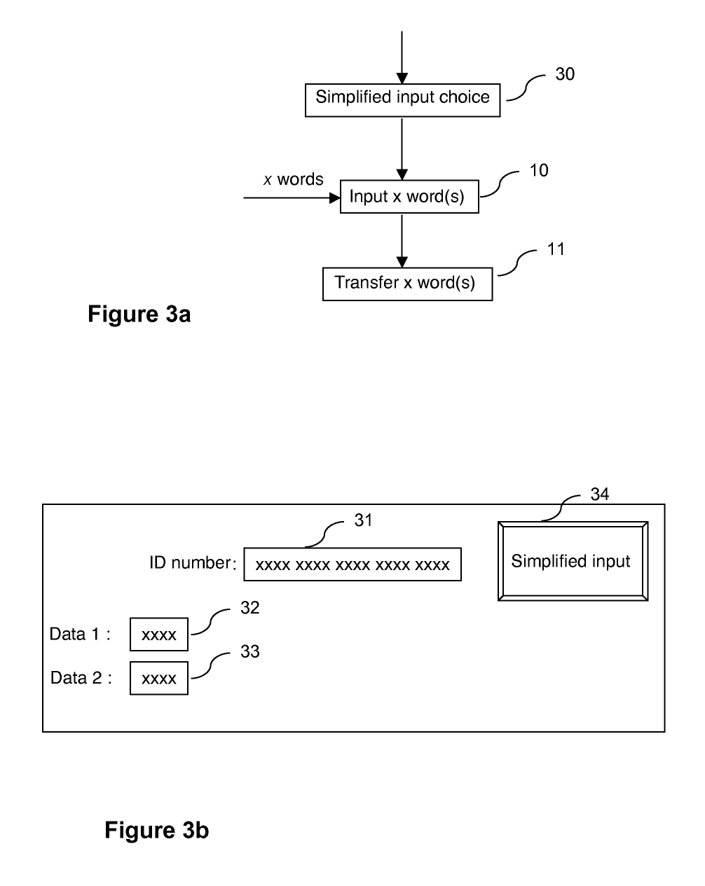

FIGS. 1 and 2 show the main steps in the method for simplifying the input, by a user, of a very long numerical sequence, according to one embodiment of the disclosure.

It is considered first of all that a user benefits from the opportunity to input a very long numerical sequence in a simplified way, and that he obtains, in a prior initialization phase, a succession of x words, associated with said very long numerical sequence.

As shown in FIG. 2, this prior initialization phase comprises a step 20 of associating, in a unique way, a succession of x words with said very long numerical sequence, by means of a pre-selected algorithm and a dictionary comprising words that are of significance to the user. This prior initialization phase may take place for example when registering the user for a service for the simplification of the input of a long code, the latter being used by him for example to authenticate himself with an Internet service, or to validate a banking transaction on an Internet shopping site, etc.

Once the prior initialization phase is complete, the user is able to use the x words instead of the very long numerical sequence, as shown in FIG. 1.

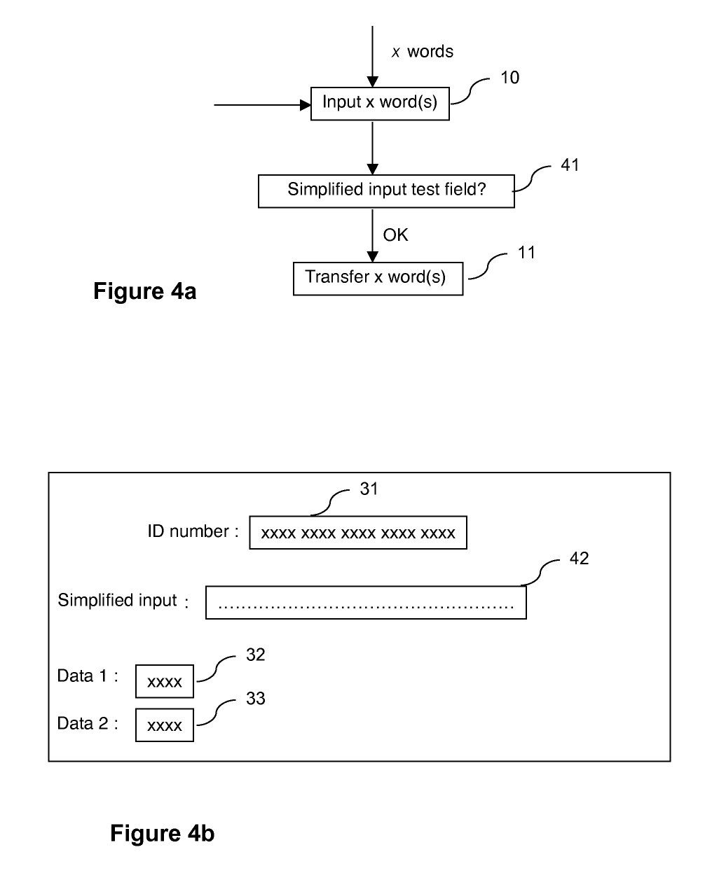

According to this embodiment of the disclosure, for authentication purposes for example, the user inputs the x words, via an input module, in an input step 10. The x words are then transferred, in a transfer step 11, to a conversion module. Two examples of simplified input are given below in accordance with two embodiment alternatives, shown in FIGS. 3a, 3b and 4a, 4b respectively.

An input module may for example be a keyboard (computer, electronic payment terminal, PDA, telephone, etc), a touch screen, or a voice input module. The input module is preferably connected to, or built into, a display module so that the user can view the numerical sequence, or the x words input.

The conversion module then processes the x words received, in a processing step 12, so as to obtain the corresponding (very long) numerical sequence. To do this, it applies the reverse algorithm of the one employed in the prior initialization phase in order to obtain the x words from the numerical sequence. Examples of algorithms used are described below.

According to this embodiment, the conversion module is independent of the input module, and has the same level of security.

The conversion module may for example be a piece of software that can be accessed via the Internet, in a secure way.

The numerical sequence so obtained by the conversion module is transmitted to the input module, which receives it in a step 13, for the purpose of using it for the remainder of the authentication procedure.

### 2. Embodiment Examples

One of the possible applications of the disclosure relates to remote banking transactions, and in particular the simplification of the input of the bank ID number necessary to validate the user transaction.

Indeed, when a user wishes to carry out a remote transaction with a bank card, via the Internet for example, on a shopping site, said site requires bank card ID data. Said data are required in a secure way, so that they cannot be used by an ill-intentioned person. This security is provided in particular by secure payment systems using secure connections, under the control of the banking institutions.

Conventionally, the data required are those that are given on the bank card in question, namely the sixteen-digit bank ID number, the card expiry date and an additional security number, known as a cryptogram, which is generally given on the reverse of the card.

The user must therefore have his bank card to hand, if he does not know all this data from memory, which is relatively difficult, in particular given the length of the ID number.

The present disclosure, according to this embodiment, therefore allows a bank card ID number to be converted into a code that is easy to remember for a user, for example a succession of words taken from a dictionary, which the user will be able to input instead of the ID number.

For example, for a French user, a bank card ID number is converted, in a unique way, into a succession of French words. This succession of words may for example include four words and is provided to the user by the inventive simplification method, in the initialization step previously described.

To be more specific, according to this embodiment, provision may be made for the user to subscribe to a service, offered by his banking institution for example, that allows him to benefit from the opportunity to input his bank ID number for remote transactions in a simplified way. In the initialization phase, the user provides the bank ID number given on his bank card and receives in return a succession of four French words.

Preferably, these four words are taken from a French language dictionary that comprises only words in common parlance, considered to be easy for a user to remember. Moreover, these words are also chosen to be of restricted length, here too in order to simplify the memorization, and subsequently the input, thereof.

According to one alternative, each word may be used in a plurality of declensions, for example in the singular, in the plural, in the masculine, feminine, in the infinitive or conjugated for a verb etc, which allows an additional encoding bit to be used per word.

According to one alternative, provision may also be made for the user to have a choice of dictionary, so as to offer a user whose mother or preferred tongue is not French the opportunity to obtain a succession of x words in another language.

An algorithm for converting a bank ID number into a succession of x words may for example divide the sixteen digits of the bank ID number into four numbers, and then apply a rule for the association of a number with a word from the dictionary. This rule of association may for example associate a number with the word that appears in the dictionary at the place corresponding to said number (with the number “1234” corresponds the 1234^{th} word in the dictionary).

According to another alternative, the algorithm may be based on a preliminary processing of the sixteen digits, a cryptographic hashing of the digits for example, in order to get to a number of y digits, each corresponding to one word in the dictionary according to a particular rule of association.

It is important to note that the succession of x words associated, in a unique way, with the bank card ID number is provided to the user in this initialization phase of the inventive method, and not chosen by the user himself. This succession of x words is not therefore saved into a database since it can be retrieved at any time via the inventive method, by applying the conversion algorithm to the bank card ID number. This feature offers more security insofar as the succession of words cannot be accessed in a database.

Once the succession of x words is provided to the user, said user is then able to use it during remote banking transactions, for example when validating an Internet transaction on a shopping site.

A plurality of embodiment alternatives of the inventive simplification method will now be given, in relation to FIGS. 3a, 3b and 4a, 4b, as regards in particular the actual simplified input.

For example, according to the alternative shown in FIGS. 3a and 3b, at the time when the user is invited to fill in the different fields 31, 32, 33, to identify his bank card, on a secure Internet page, he also has the opportunity to choose, in a step 30, a simplified input mode, by clicking on a button 34. This action 30 opens another input window for example, in which the user is able to input the x words, in an input step 10. These x words are then transferred to the conversion module, in a transfer step 11, already previously described. The conversion module then carries out the appropriate processing on the x words in order to deliver the corresponding bank card ID number, so that the transaction can be validated, according to a known technique for ensuring the security of Internet banking transactions.

According to another alternative, shown in FIGS. 4a and 4b, the secure Internet page inviting the user to fill in his bank card ID fields also offers a field 42 specific to simplified input. The user is then able to choose the input mode he prefers, simply by filling in the appropriate field. If the user chooses the simplified input mode, he then fills in the field 42, in an input step 10. When he validates his input, a test is carried out on the input field, in order to determine whether it is the simplified input field 42. If this is the case, then the x words input are transferred, in a transfer step 11 already previously described. The conversion module then carries out the appropriate processing on the x words in order to deliver the corresponding bank card ID number, so that the transaction can be validated, according to a known technique for ensuring the security of Internet banking transactions.

### 3. Structure of an Input Simplification Device

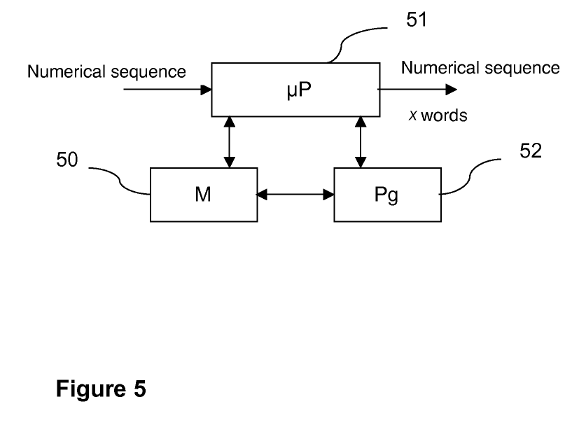

Finally an illustration is given in relation to FIG. 5, of the simplified structure of an input simplification device that uses a technique for simplifying the inputting of a very long numerical sequence according to one embodiment of the disclosure.

Said signature device comprises a memory 51 constituted by a buffer memory, a processing unit 52, equipped with a μP microprocessor for example, and controlled by the computer program 53, using the inventive input simplification method.

At initialization, the code instructions of the computer program 53 are for example loaded into a RAM memory before being run by the processor of the processing unit 52. The processing unit 52 receives at input at least one very long numerical sequence. The microprocessor of the processing unit 52 implements the steps in the input simplification method previously described, according to the instructions of the computer program 53. To do this, the input simplification device comprises, apart from the buffer memory 51, a device for the input of at least one word forming alphanumerical sequences, said word or words being previously associated with said numerical sequence, a device for the transfer of said word or words to a conversion module, a device for the reception, via said input module, of said numerical sequence, provided by said conversion module, after said words have been processed, said words having been determined and provided to the user by said conversion module, in a prior initialization phase, by a conversion algorithm that associates said word or words in a unique way with a very long numerical sequence, said word or words being chosen from a pre-selected dictionary consisting of words that are of significance to the user. These devices are controlled by the microprocessor of the processing unit 52.

The processing unit 52 therefore provides a very long numerical sequence equal to that provided by the user in the initialization phase, as well as a sequence of x words corresponding to the simplification of said very long numerical sequence.

An exemplary embodiment of the disclosure provides a technique for making it more straightforward, for the user, to input very long numerical sequences.

An exemplary embodiment provides a technique of said kind for simplifying the input of very long numerical sequences, which is relatively inexpensive and straightforward to implement, and compatible with current technology.

Although the present disclosure has been described with reference to one or more examples, workers skilled in the art will recognize that changes may be made in form and detail without departing from the scope of the disclosure and/or the appended claims.

What is claimed is:

1. A method for simplifying an input, by a user, of a very long numerical sequence, via an input module of a communications terminal, wherein the method comprises the following steps:
inputting, via said input module, at least one word forming alphanumerical sequences, said at least one word being previously associated with said numerical sequence;
transferring said at least one word to a conversion module;
receiving, by said input module, said numerical sequence, provided by said conversion module, after said words have been processed,
said words having been determined and provided to the user by said conversion module, in a prior initialization phase, by a conversion algorithm that associates said at least one word in a unique way with the very long numerical sequence, said at least one word being chosen from a pre-selected dictionary comprising words that are of significance to the user.

2. The method of claim 1, wherein said step of inputting at least one word is carried out after a step of requesting use of a simplified input mode by said user.

3. The method of claim 1, wherein the method employs two alternative input fields, a first field for direct input of said very long numerical sequence and a second field for input of said at least one word, and wherein said word is transferred to said conversion module when said step of inputting at least one word is carried out in said second field.

4. The method of claim 1, wherein said at least one word is chosen from a dictionary that comprises only words in common parlance for said user.

5. The method of claim 1, wherein the method also comprises a prior step of choosing one dictionary from a plurality of dictionaries.

6. The method of claim 1, wherein said at least one word includes a number of letters below a preset threshold.

7. The method of claim 1, wherein declensions or conjugations of said at least one word may be chosen.

8. The method of claim 1, wherein said numerical sequence corresponds to a bank identification number, said input by a user being required for authentication of a remote banking transaction.

9. A device for simplifying input, by a user, of a very long numerical sequence, wherein said device is associated with an input module of a communications terminal, and wherein the device comprises:
means for inputting, via said input module, at least one word forming alphanumerical sequences, said at least one word being previously associated with said numerical sequence;
means for transferring said at least one word to a conversion module;
means for receiving, via said input module, said numerical sequence, provided by said conversion module, after said at least one word has been processed, said at least one word having been determined and provided to the user by said conversion module, in a prior initialization phase, by a conversion algorithm that associates said at least one word in a unique way with a very long numerical sequence, said at least one word being chosen from a pre-selected dictionary comprising words that are of significance to the user.

10. A non-transient computer-readable medium comprising comprises program code instructions recorded thereon for performing a method for simplifying an input, by a user, of a very long numerical sequence, via an input module of a communications terminal, wherein the method comprises:
inputting, via said input module, at least one word forming alphanumerical sequences, said at least one word being previously associated with said numerical sequence;
transferring said at least one word to a conversion module;
receiving, by said input module, said numerical sequence, provided by said conversion module, after said words have been processed,
said words having been determined and provided to the user by said conversion module, in a prior initialization phase, by a conversion algorithm that associates said at least one word in a unique way with the very long numerical sequence, said at least one word being chosen from a pre-selected dictionary comprising words that are of significance to the user.
